(19) United States
(12) Patent Application Publication
(10) Pub. No.: US 2006/0075053 A1
(43) Pub. Date: Apr. 6, 2006

(54) Method for representing virtual image on instant messaging tools

(76) Inventors: Liang Xu, Shenzhen (CN); Lin Xia, Shenzhen (CN); Lin Xu, Shenzhen (CN); Yan Jia, Shenzhen (CN); Song Mai, Shenzhen (CN)

Correspondence Address: HARNESS, DICKEY & PIERCE, P.L.C., P.O. BOX 828, BLOOMFIELD HILLS, MI, 48303, US

(21) Appl. No.: 11/239,680

(22) Filed: Sep. 29, 2005

Related U.S. Application Data
(63) Continuation of application No. PCT/CN04/00399, filed on Apr. 26, 2004.

(30) Foreign Application Priority Data
Apr. 25, 2003 (CN) 03114305.9

(51) Int. Cl. G06F 15/16

(52) U.S. Cl. 709/206

(57) ABSTRACT

The present invention discloses a method for representing avatar on Instant Messenger, which comprises the following steps: step A: Instant Messenger sends a request for obtaining avatar to avatar picture server; step B: according to the received request for obtaining avatar, avatar picture server obtains corresponding avatar picture from avatar file server, transforms this avatar picture into picture information, and then transmits this picture information to the said Instant Messenger in step A; step C: Instant Messenger displays the avatar picture according to the received picture information. Messaging service function of Instant Messenger is extended in the present invention, and additional incremental capability is increased.

### CROSS-REFERENCE TO RELATED APPLICATIONS

This application is a continuation of International Application No. PCT/CN2004/000399 filed on Apr. 26, 2004. This application claims the benefit of Chinese Application No. 03114305.9 filed on Apr. 25, 2003. The disclosures of the above applications are incorporated herein by reference.

### FIELD OF THE INVENTION

The present invention relates to electric communication technique, more particularly to a method for representing virtual image on instant messaging tools.

### BACKGROUND OF THE INVENTION

Network Instant Messaging (IM) service is a messaging service based on the Internet, mainly implementing network instant messaging function, and instant messaging tool is widely applied and approbated on the Internet. Moreover, internet instant messaging service is also extending in direction of combining with network virtual community gradually, which embodies development direction of network instant messaging service, for instance, the very reputable instant messaging tool of is widely approbate and favored by most netizen by right of fastness, abundant functions, stable application and exquisite quality. Subscribers can perform operations like receiving and sending messages, transmitting files, video telephone and sending short message of cell phone. Network virtual image is applied in some network games, and the network virtual image is represented as images of the gamer in the game. By combining network virtual image with network instant messaging service that is widely applied at present, better visual effect can be provided for subscribers of instant messaging service, accordingly service quality of network instant messaging service can be increased. However, in existing technology, network virtual image cannot be displayed by instant messaging tools, so the above-mentioned object is difficult to achieve.

### SUMMARY OF THE INVENTION

The main object of the present invention is to provide a method for displaying network virtual image on instant messaging tools, so as to solve the problem in existing technology that instant messaging tools cannot display network virtual image.

In present invention, avatar represents the said virtual image, and the instant messenger represents the said instant messaging tools.

To obtain the above object, a method for representing avatar on Instant Messenger, comprising:

Step A: Instant Messenger sending a request for obtaining avatar to avatar picture server;

Step B: according to the received request for obtaining avatar, avatar picture server obtaining corresponding avatar pictures form avatar file server, transforming the avatar pictures into picture information, and then returning this picture information thereof to the said Instant Messenger in step A;

Step C: Instant Messenger displaying avatar pictures according to the received picture information.

Wherein step A comprising:

Instant Messenger calling avatar display logic, sending the said request to avatar picture server through network communication interface logic of this Instant Messenger.

Wherein step A comprising:

Step A1: Instant Messenger calling avatar update logic, sending a request for obtaining time stamp when last modifying network avatar through network communication interface logic of this Instant Messenger;

Step A2: according to the received request, avatar picture server obtaining time stamp when last modifying the virtual module from avatar file server through avatar file access logic and avatar data and file access module;

Step A3: comparing the local time stamp on Instant Messenger with the time stamp when last modifying network avatar obtained from avatar file server, if the said time stamp when last modifying the avatar is larger than the said local time stamp, executing step A4;

Step A4: Instant Messenger sending the said request for obtaining avatar to avatar picture server.

Wherein step A3 comprising:

Step A31: avatar picture server sending the time stamp when last modifying the avatar, which is obtained from avatar file server, to the said Instant Messenger;

Step A32: the said Instant Messenger calling avatar update logic comparing the said the time stamp when last modifying the avatar sent by avatar picture server with local time stamp of this Instant Messenger, if the time stamp when last modifying the virtual module is larger than the said local time stamp, executing step A4.

Wherein step A3 comprising:

Step A31a: avatar picture server comparing the time stamp when last modifying the avatar obtained from avatar file server with local time stamp of the said Instant Messenger, and transmitting the comparing result to the said Instant Messenger;

Step A32a: Instant Messenger judging the received comparing result, if this comparing result is the time stamp when last modifying the avatar larger than the said local time stamp, executing step A4.

Wherein step C further comprising:

Instant Messenger obtaining the last modified time stamp of network avatar, updating local time of this Instant Messenger thereof according to this obtained time stamp.

Wherein prior to the said step A1, Instant Messenger further judging whether avatar update event is detected, if yes, executing the said step A1.

Wherein the said avatar update event being friend subscriber logging on line or actively requesting to update the avatar picture.

Wherein the said step A2 further comprising:

Avatar picture server checking whether the request protocol sent by Instant Messenger is legal, if legal, executing the said step A2, otherwise, aborting the current request.

Wherein step B comprising:

Step B1: according to contents of the said request for obtaining avatar, avatar picture server obtaining corresponding avatar picture of binary format from avatar file server;

Step B2: avatar picture server transforming the avatar picture of binary format into picture information, then returning this picture information to the said Instant Messenger.

Wherein step C comprising:

Step C1: Instant Messenger receiving picture information transmitted by avatar picture server through network communication interface logic;

Step C2: Instant Messenger calling avatar display logic to analyze the received picture information, restoring this picture information to avatar picture;

Step C3: Instant Messenger displaying the avatar picture through avatar representing module.

The method further comprising:

Step D: avatar editing terminal receiving the virtual picture information input by the subscriber, processing the virtual picture information and then transmitting the processed information to image processing server, image processing server generating corresponding avatar picture according to the received virtual picture information, and then storing this picture in avatar file server.

Wherein step D comprising:

Step D1: avatar editing terminal receiving the virtual picture information input by the subscriber;

Step D2: avatar editing terminal selecting and/or previewing image component with virtual picture information through avatar component selector and/or avatar synthetic preview, then storing the virtual picture information after selection and/or preview operation;

Step D3: avatar storage interface in avatar editing terminal transmitting virtual picture information to interface module of Hyper Text Transfer Protocol (HTTP);

Step D4: the said interface module integrating relevant subscriber information, virtual picture information as well as each corresponding sub-item into a protocol packet with coding and transmitting this packet to image processing server;

Step D5: image processing server generating corresponding avatar picture according to contents of the received protocol packet, and storing this avatar picture in avatar file server.

Wherein after step D5, further comprising:

Step D6: image processing server returning the stored result to interface module of avatar editing terminal.

Wherein step B further comprising:

Avatar picture server checking whether the request protocol sent by Instant Messenger is legal, if legal, executing step B, otherwise, aborting the current request.

Wherein in step A, Instant Messenger sending the said request for obtaining avatar through protocol packet;

In step B, avatar picture server returning picture information to the said Instant Messenger through protocol packet;

In step C, Instant Messenger analyzing the received protocol packet, displaying the avatar picture according to picture information in this protocol packet.

Wherein in step A1, Instant Messenger sending a request for obtaining the last modified network avatar time stamp to avatar picture server through a protocol packet;

In step A2, according to contents of the received protocol packet, avatar picture server obtaining the last modified network avatar time stamp from avatar file server;

In step A31, avatar picture server transmitting the last modified network avatar time stamp to the said Instant Messenger through protocol packet;

In step A32, Instant Messenger analyzing the received protocol packet and obtaining the said last modified network avatar time stamp, and then comparing the said last modified network avatar time stamp with local time stamp of Instant Messenger;

In step A4, Instant Messenger sending the said request for obtaining avatar to avatar picture server through protocol packet.

Wherein in step A1, Instant Messenger sending the said request for obtaining the last modified network avatar time stamp to avatar picture server through protocol packet;

In step A2, according to contents of the received protocol packet, avatar picture server obtaining the last modified network avatar time stamp from avatar file server;

In step A31a, avatar picture server transmitting the comparing result to the said Instant Messenger through protocol packet;

In step A32a, Instant Messenger obtaining the said comparing result by analyzing the received protocol packet, if this comparing result is the said last modified network avatar time stamp being larger than the said location time stamp, executing step A4;

In step A4, Instant Messenger sending the said request for obtaining avatar to avatar picture server through protocol packet.

Favorable effect of the present invention lies in that: in the present invention, request concerning network avatar is sent to avatar picture server through Instant Messenger, according to contents of the protocol packet, avatar picture server obtains corresponding network avatar picture form avatar file server and transforms the picture into corresponding response protocol packet, and sends this response protocol packet to Instant Messenger, Instant Messenger restores the picture information in response protocol packet to the required network avatar picture, in the network, most netizen want to represent the perfect side to others, in this way, to display network avatar in Instant Messenger is in psychological need of the netizen, and better visual effect can be provided for subscribers of instant messaging service, with pretty high economical value, therefore, messaging service function of Instant Messenger is extended in the present invention, and additional incremental capability is increased.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram illustrating structure of the present invention;

FIG. 2 is a schematic diagram illustrating connecting structure of Instant Messenger and avatar picture server in the present invention;

FIG. 3 is a schematic diagram illustrating connecting structure of avatar editing terminal and avatar image processing server.

### DETAILED DESCRIPTION OF THE PREFERRED EMBODIMENTS

The following description of the preferred embodiment(s) is merely exemplary in nature and is in no way intended to limit the invention, its application, or uses.

The present invention will be described in detail hereinafter with reference to the accompanying drawings. In the below embodiments of the present invention, avatar represents the said virtual image, and the instant messenger represents the said instant messaging tools

### Embodiment 1

Specific procedure of displaying network avatar on Instant Messenger is as follows:

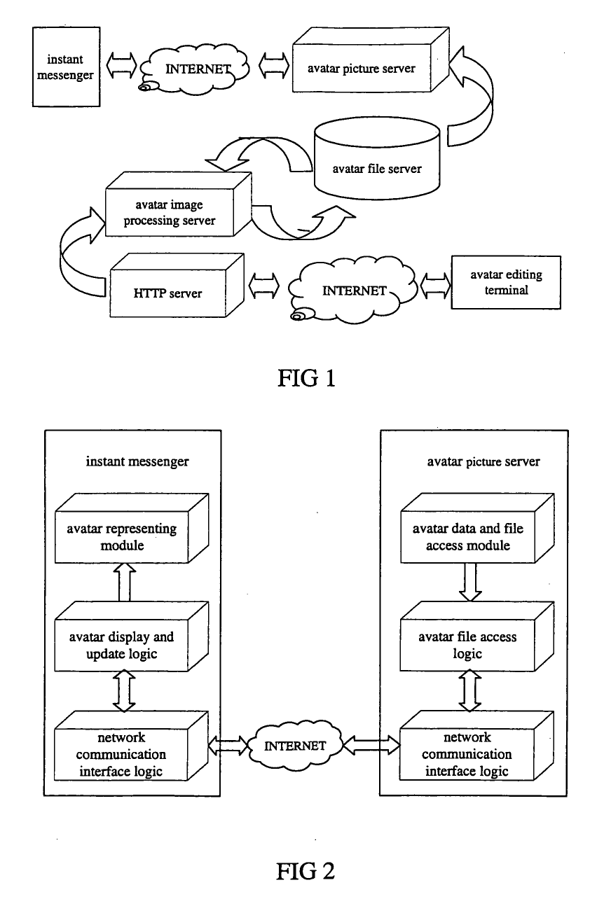

step 1: as shown in FIG. 1 and FIG. 2, avatar display logic in Instant Messenger is called, request concerning network avatar is sent to avatar picture server through network communication interface logic, wherein the request comprises information like subscriber information and request type and so on, the information constitutes a protocol packet.

step 2: as shown in FIG. 1, avatar picture server checks whether the request protocol packet sent by Instant Messenger is legal, if legal, the following step 3 will be executed; otherwise, the current request will be abandoned.

step 3: as shown in FIG. 1, according to contents of the protocol packet in avatar request, avatar picture server obtains corresponding network avatar picture in binary format from avatar file server and transforms the obtained picture into corresponding response protocol packet comprising picture information;

step 4: as shown in FIG. 1, avatar picture server transmits the response protocol packet to Instant Messenger through network protocol;

step 5: as shown in FIG. 1 and 2, network communication interface logic in Instant Messenger receives the response protocol packet transmitted by avatar picture server, calls avatar display logic to analyze the response protocol packet transmitted by avatar picture server, restores picture information in the response protocol packet to the requested network avatar picture, and displays the avatar picture through avatar representing module, like displaying network avatar of the subscriber in subscriber detailed information, TIP open window of subscriber friend board as well as TIP open window of chat window of Instant Messenger.

### Embodiment 2

Specific procedure of storing network avatar through Instant Messenger is as follows:

Step 1: the subscriber logs on avatar editing terminal.

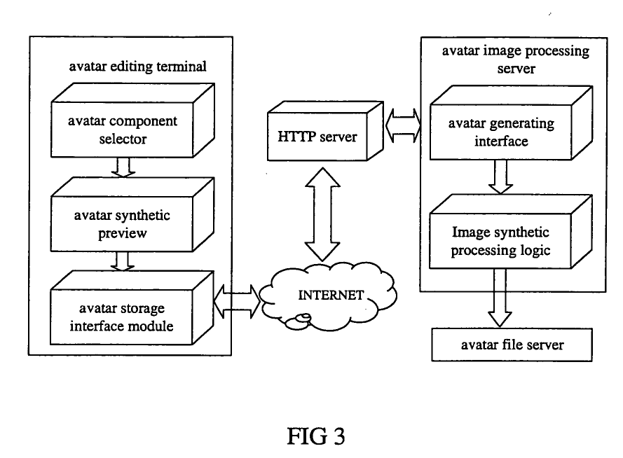

Step 2: as shown in FIGS. 1 and 3, the subscriber inputs network virtual picture information, avatar editing terminal selects and/or previews avatar component with the virtual picture information through the avatar component selector and/or avatar synthetic preview, subscriber stores the selected picture information thereafter, the stored network virtual picture information and other information is transmitted to network server through the Internet by way of avatar storage interface in avatar editing terminal, wherein, in the embodiment of the present invention, Hyper Text Transfer Protocol (HTTP) server is employed as this network server thereof.

Step 3: as shown in FIG. 1, interface module in HTTP server judges whether it is required to take each sub item as a new network avatar, if yes, interface module will integrate relevant subscriber information, related network virtual picture information and each corresponding sub item into a protocol packet by the way of coding; wherein, sub item demotes constituent of avatar, and each sub item represents a constituent, like dressing, trousers, headwear and background, of one avatar.

Step 4: as shown in FIG. 1, this interface module transmits the protocol packet comprising network virtual picture information to image processing server by way of TCP/IP protocol.

Step 5: as shown in FIGS. 1 and 3, image processing server receives the protocol packet comprising network virtual picture information through avatar generating interface, then contents of the protocol packet is synthesized into corresponding network avatar picture by image synthetic processing logic, relevant pictures and information are respectively transmitted to corresponding avatar file server for storage.

Step 6: as shown in FIG. 1, image processing server returns the stored result to interface module of avatar editing terminal by way of TCP protocol.

### Embodiment 3

Specific procedure of updating network avatar through Instant Messenger is as follows:

Step 1: as shown in FIGS. 1 and 2, Instant Messenger judges whether avatar update event, like a certain friend subscriber logging on line or the subscriber actively requesting to update network avatar of a certain friend, is detected, if yes, namely avatar update logic in Instant Messenger is called, the request for obtaining the time stamp when last modifying network avatar is sent to avatar picture server through network communication interface logic.

Step 2: as shown in FIGS. 1 and 2, after receiving the request sent by Instant Messenger through the network communication interface logic thereof, avatar picture server obtains the time stamp when last modifying network virtual picture from avatar file server by way of avatar file access logic and avatar data and file access module.

Step 3: as shown in FIG. 1, avatar picture server checks whether the request protocol sent by Instant Messenger is legal, if legal, according to contents of the protocol packet in the request for obtaining the time stamp when last modifying network virtual module, avatar picture server obtains the time stamp when last modifying network avatar from avatar file server; otherwise, the current request will be aborted.

Step 4: as shown in FIG. 1, avatar picture server constitutes information concerning time stamp when last modifying the avatar into a response protocol packet, and transmits this packet to Instant Messenger.

Step 5: as shown in FIGS. 1 and 2, network communication interface logic in Instant Messenger receives the response protocol packet returned by avatar picture server, analyzes the protocol packet returned by avatar picture server, calls avatar update logic to compare the time stamp returned by avatar picture server with local time stamp.

Step 6: as shown in FIG. 1, if the returned time stamp is larger than local time stamp, it is indicated that network avatar needs updating.

Step 7: as shown in FIG. 1, Instant Messenger integrates relevant subscriber information and request type and so on into a protocol packet, and sends a request for obtaining network avatar to avatar picture server by way of network protocol.

Step 8: as shown in FIG. 1, avatar picture server checks whether the request sent by Instant Messenger is legal, if legal, step 9 is executed; otherwise, the current request will be aborted.

Step 9: as shown in FIG. 1, according to contents of the protocol packet in avatar request, avatar picture server obtains corresponding network avatar picture and transforms the picture into a corresponding response protocol packet.

Step 10: as shown in FIG. 1, avatar picture server sends the response protocol packet to Instant Messenger by way of network protocol.

Step 11: as shown in FIG. 1, Instant Messenger restores the picture information in response protocol packet to the requested network avatar picture, meanwhile, obtains the time stamp when last modifying network avatar, and updates local time stamp of subscriber's network avatar using this obtained time stamp.

### Embodiment 4

Specific procedure of updating network avatar through Instant Messenger can be as follows alternately:

Step 1: as shown in FIGS. 1 and 2, when a certain friend subscriber in the Instant Messenger logs on line or the subscriber actively requests to update network avatar of a certain friend, avatar update logic in Instant Messenger is called, the request for obtaining the time stamp when last modifying network avatar is sent to avatar picture server through network communication interface logic.

Step 2: as shown in FIGS. 1 and 2, after receiving the request sent by Instant Messenger through the network communication interface logic thereof, avatar picture server obtains the time stamp when last modifying network avatar from avatar file server by way of avatar file access logic and avatar data and file access module.

Step 3: as shown in FIG. 1, avatar picture server checks whether the request protocol sent by Instant Messenger is legal, if legal, according to contents of the protocol packet in the request for obtaining the time stamp when last modifying network avatar, avatar picture server obtains the time stamp when last modifying network avatar from avatar file server; otherwise, the current request will be aborted.

Step 4: as shown in FIG. 1, avatar picture server compares the time stamp when last modifying the avatar transmitted by avatar file server with the time stamp on Instant Messenger.

Step 5: as shown in FIG. 1, avatar picture server transforms the comparing result into a response protocol packet, if the time stamp returned from avatar file server is larger than that on Instant Messenger, it is indicated that network avatar needs updating, and the result is transmitted to Instant Messenger.

Step 6: as shown in FIGS. 1 and 2, network communication interface logic in Instant Messenger receives the response protocol packet returned by avatar picture server, analyzes the protocol packet returned by avatar picture server, integrates relevant subscriber information and request type and so on into a protocol packet, and sends a request for obtaining network avatar to avatar picture server by way of network protocol.

Step 7: as shown in FIG. 1, avatar picture server checks whether the request sent by Instant Messenger is legal, if legal, step 8 is executed; otherwise, the current request will be aborted.

Step 8: as shown in FIG. 1, according to contents of the protocol packet in avatar request, avatar picture server obtains corresponding network avatar picture and transforms the picture into a corresponding response protocol packet.

Step 9: as shown in FIG. 1, avatar picture server sends the response protocol packet to Instant Messenger by way of network protocol.

Step 10: as shown in FIG. 1, Instant Messenger restores the picture information in response protocol packet to the requested network avatar picture, meanwhile, obtains the time stamp when last modifying network avatar, and updates local time stamp of subscriber's network avatar using this obtained time stamp.

The description of the invention is merely exemplary in nature and, thus, variations that do not depart from the gist of the invention are intended to be within the scope of the invention. Such variations are not to be regarded as a departure from the spirit and scope of the invention.

1. A method for representing virtual image on instant messaging tool, comprising:
step A: instant messaging tool sending a request for obtaining virtual image to virtual image picture server;
step B: according to the received request for obtaining virtual image, virtual image picture server obtaining corresponding virtual image pictures form virtual image file server, transforming the virtual image pictures into picture information, and then returning this picture information thereof to the said instant messaging tool in step A;
step C: instant messaging tool displaying virtual image pictures according to the received picture information.

2. The method according to claim 1, wherein step A comprising:
Instant messaging tool calling virtual image display logic, sending the said request to virtual image picture server through network communication interface logic of this instant messaging tool.

3. The method according to claim 1, wherein step A comprising:
step A1: instant messaging tool calling virtual image update logic, sending a request for obtaining time stamp when last modifying network virtual image through network communication interface logic of this instant messaging tool;
step A2: according to the received request, virtual image picture server obtaining time stamp when last modifying the virtual module from virtual image file server through virtual image file access logic and virtual image data and file access module;
step A3: comparing the local time stamp on instant messaging tool with the time stamp when last modifying network virtual image obtained from virtual image file server, if the said time stamp when last modifying the virtual image is larger than the said local time stamp, executing step A4;
step A4: instant messaging tool sending the said request for obtaining virtual image to virtual image picture server.

4. The method according to claim 3, wherein step A3 comprising:
step A31: virtual image picture server sending the time stamp when last modifying the virtual image, which is obtained from virtual image file server, to the said instant messaging tool;
step A32: the said instant messaging tool calling virtual image update logic, comparing the said the time stamp when last modifying the virtual image sent by virtual image picture server with local time stamp of this instant messaging tool, if the time stamp when last modifying the virtual module is larger than the said local time stamp, executing step A4.

5. The method according to claim 3, wherein step A3 comprising:
step A31a: virtual image picture server comparing the time stamp when last modifying the virtual image obtained from virtual image file server with local time stamp of the said instant messaging tool, and transmitting the comparing result to the said instant messaging tool;
step A32a: instant messaging tool judging the received comparing result, if this comparing result is the time stamp when last modifying the virtual image larger than the said local time stamp, executing step A4.

6. The method according to claim 3, wherein step C further comprising:
instant messaging tool obtaining the last modified time stamp of network virtual image, updating local time of this instant messaging tool thereof according to this obtained time stamp.

7. The method according to claim 3, wherein prior to the said step A1, instant messaging tool further judging whether virtual image update event is detected, if yes, executing the said step A1.

8. The method according to claim 7, wherein the said virtual image update event being friend subscriber logging on line or actively requesting to update the virtual image picture.

9. The method according to claim 3, wherein the said step A2 further comprising:
virtual image picture server checking whether the request protocol sent by instant messaging tool is legal, if legal, executing the said step A2, otherwise, aborting the current request.

10. The method according to claim 1, wherein step B comprising:
step B1: according to contents of the said request for obtaining virtual image, virtual image picture server obtaining corresponding virtual image picture of binary format from virtual image file server;
step B2: virtual image picture server transforming the virtual image picture of binary format into picture information, then returning this picture information to the said instant messaging tool.

11. The method according to claim 1, wherein step C comprising:
Step C1: instant messaging tool receiving picture information transmitted by virtual image picture server through network communication interface logic;
Step C2: instant messaging tool calling virtual image display logic to analyze the received picture information, restoring this picture information to virtual image picture;
Step C3: instant messaging tool displaying the virtual image picture through virtual image representing module.

12. The method according to claim 1, further comprising:
step D: virtual image editing terminal receiving the virtual picture information input by the subscriber, processing the virtual picture information and then transmitting the processed information to image processing server, image processing server generating corresponding virtual image picture according to the received virtual picture information, and then storing this picture in virtual image file server.

13. The method according to claim 12, wherein step D comprising:
step D1: virtual image editing terminal receiving the virtual picture information input by the subscriber;
step D2: virtual image editing terminal selecting and/or previewing image component with virtual picture information through virtual image component selector and/or virtual image synthetic preview, then storing the virtual picture information after selection and/or preview operation;
step D3: virtual image storage interface in virtual image editing terminal transmitting virtual picture information to interface module of Hyper Text Transfer Protocol (HTTP);
step D4: the said interface module integrating relevant subscriber information, virtual picture information as well as each corresponding sub-item into a protocol packet with coding and transmitting this packet to image processing server;
step D5: image processing server generating corresponding virtual image picture according to contents of the received protocol packet, and storing this virtual image picture in virtual image file server.

14. The method according to claim 13, wherein after step D5, further comprising:
step D6: image processing server returning the stored result to interface module of virtual image editing terminal.

15. The method according to claim 1, wherein step B further comprising:
virtual image picture server checking whether the request protocol sent by instant messaging tool is legal, if legal, executing step B, otherwise, aborting the current request.

16. The method according to claim 1, wherein in step A, instant messaging tool sending the said request for obtaining virtual image through protocol packet;
in step B, virtual image picture server returning picture information to the said instant messaging tool through protocol packet;
in step C, instant messaging tool analyzing the received protocol packet, displaying the virtual image picture according to picture information in this protocol packet.

17. The method according to claim 4, wherein in step Al, instant messaging tool sending a request for obtaining the last modified network virtual image time stamp to virtual image picture server through a protocol packet;
in step A2, according to contents of the received protocol packet, virtual image picture server obtaining the last modified network virtual image time stamp from virtual image file server;
in step A31, virtual image picture server transmitting the last modified network virtual image time stamp to the said instant messaging tool through protocol packet;
in step A32, instant messaging tool analyzing the received protocol packet and obtaining the said last modified network virtual image time stamp, and then comparing the said last modified network virtual image time stamp with local time stamp of instant messaging tool;
in step A4, instant messaging tool sending the said request for obtaining virtual image to virtual image picture server through protocol packet.

18. The method according to claim 5, wherein in step A1, instant messaging tool sending the said request for obtaining the last modified network virtual image time stamp to virtual image picture server through protocol packet;
in step A2, according to contents of the received protocol packet, virtual image picture server obtaining the last modified network virtual image time stamp from virtual image file server;
in step A31a, virtual image picture server transmitting the comparing result to the said instant messaging tool through protocol packet;
in step A32a, instant messaging tool obtaining the said comparing result by analyzing the received protocol packet, if this comparing result is the said last modified network virtual image time stamp being larger than the said location time stamp, executing step A4;
in step A4, instant messaging tool sending the said request for obtaining virtual image to virtual image picture server through protocol packet.

19. The method according to claim 4, wherein step C further comprising:
instant messaging tool obtaining the last modified time stamp of network virtual image, updating local time of this instant messaging tool thereof according to this obtained time stamp.

20. The method according to claim 5, wherein step C further comprising:
instant messaging tool obtaining the last modified time stamp of network virtual image, updating local time of this instant messaging tool thereof according to this obtained time stamp.
